(19) United States
(12) Patent Application Publication
(10) Pub. No.: US 2017/0343682 A1
(43) Pub. Date: Nov. 30, 2017

(54) SYSTEM AND METHODOLOGY UTILIZING A RADIATION DETECTOR

(71) Applicant: Schlumberger Technology Corporation, Sugar Land, TX (US)

(72) Inventors: Irina Shestakova, Princeton, NJ (US); Olivier Philip, Princeton Junction, NJ (US); Sameer Pandya, Secaucus, NJ (US); Adrish Ganguly, Lawrenceville, NJ (US)

(21) Appl. No.: 15/163,889

(22) Filed: May 25, 2016

(51) Int. Cl. G01T 1/202; G01V 5/04; G01T 1/20

(52) U.S. Cl. CPC G01T 1/2026; G01T 1/2002; G01V 5/04

(57) ABSTRACT

A technique facilitates use of radiation sampling techniques in subterranean formation environments or other environments. A radiation detector may be constructed utilize a scintillator package having a scintillating crystal. The scintillating crystal is combined with a reflector positioned to reflect light otherwise leaving a surface of the scintillating crystal. The reflector incorporates nano materials, e.g. nano particles or nano fibers, arranged to provide highly reflective properties. By way of example, the nano materials may be fabricated in a separate layer combined with the scintillating crystal or applied directly onto a surface of the scintillating crystal.

### BACKGROUND

In many hydrocarbon well applications, well logging is used to collect data on formations which may contain reservoirs of hydrocarbon fluids. For example, nuclear gamma-ray techniques can be used for taking downhole measurements and those techniques include natural gamma ray detection, density logging, formation sigma measurement, and neutron induced gamma ray spectroscopy. Such measurement techniques may utilize a nuclear detector which may be positioned to sample nuclear radiation produced by a radiation generator. The nuclear detector may be positioned downhole in a wellbore, but downhole wellbore environments can subject the detector to difficult and sometimes harsh conditions.

### SUMMARY

In general, a system and methodology facilitate the use of radiation sampling techniques. According to an embodiment, a radiation detector utilizes a scintillator package having a scintillating crystal. The scintillating crystal is combined with a reflector positioned to reflect light leaving a surface of the scintillating crystal. The reflector incorporates nano structures, e.g. nano particles or nano fibers, arranged to provide highly reflective properties. By way of example, the nano materials may be fabricated in a separate layer combined with the scintillating crystal or applied directly onto a surface of the scintillating crystal.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of a well system deployed in a borehole and comprising a radiation detector, according to an embodiment of the disclosure;

FIG. 2 is a schematic, exploded illustration of an example of a radiation detector comprising a scintillation detector package having a scintillating crystal surrounded by a reflector, according to an embodiment of the disclosure;

FIG. 3 is a schematic illustration of an example of a reflector compound having inorganic oxides of varying sizes suspended within an organic binding material, according to an embodiment of the disclosure;

FIG. 4 is a schematic illustration of an example of a reflector compound having inorganic oxides of varying sizes suspended within an organic binding material, the inorganic oxides being shown graduated from heaviest to lightest weight, according to an embodiment of the disclosure;

FIG. 5 is a cross-sectional, schematic illustration of an example of a scintillation detector package having a reflective, shock absorbing compound surrounding a scintillating crystal, according to an embodiment of the disclosure;

FIG. 6 is a cross-sectional, schematic illustration of another example of a scintillation detector package having a reflective, shock absorbing compound surrounding a scintillating crystal, according to an embodiment of the disclosure;

FIG. 7 is a cross-sectional, schematic illustration of another example of a scintillation detector package having a reflective, shock absorbing compound surrounding a scintillating crystal, according to an embodiment of the disclosure;

FIG. 8 is a cross-sectional, schematic illustration of another example of a scintillation detector package having a reflective, shock absorbing compound surrounding a scintillating crystal, according to an embodiment of the disclosure;

FIG. 9 is an illustration comparing a scintillating detector assembly having a polytetrafluoroethylene (PTFE) reflector and a reflector prepared according to an embodiment of the disclosure;

FIG. 10 is a graphical illustration comparing the spectrum response of the two detector assemblies having the two different types of reflectors illustrated in FIG. 9, according to an embodiment of the disclosure;

FIG. 11 is another graphical illustration showing the spectrum response of a detector assembly having another type of reflector, according to an embodiment of the disclosure;

FIG. 12 is an illustration of an example of a scintillating crystal having a reflector deposited onto a surface of the scintillating crystal, according to an embodiment of the disclosure;

FIG. 13 is an illustration of an example of a scintillating crystal having a reflector formed via deposition of nano particles onto a substrate, according to an embodiment of the disclosure;

FIG. 14 is an illustration of an example of a scintillating crystal having a reflector formed via deposition of nano fibers, e.g. nano tubes, onto a substrate, according to an embodiment of the disclosure;

FIG. 15 is an illustration of an example of a scintillating crystal having a reflector formed via deposition of nano particles and nano tubes onto a substrate, according to an embodiment of the disclosure;

FIG. 16 is an illustration of an example of a scintillating crystal having a reflector formed via suspension of nano particles into a transparent substrate, according to an embodiment of the disclosure;

FIG. 17 is an illustration of an example of a scintillating crystal having a reflector formed via suspension of nano fibers into a transparent substrate, according to an embodiment of the disclosure;

FIG. 18 is an illustration of an example of a scintillating crystal having a reflector formed via suspension of nano particles and nano fibers into a transparent substrate, according to an embodiment of the disclosure;

FIG. 19 is an illustration of an example of a scintillating crystal having a reflector formed via adhesion of a random, nano fiber network onto an elastomer film, according to an embodiment of the disclosure; and

FIG. 20 is an illustration of an example of a scintillating crystal having a reflector formed via adhesion of a nano fiber cloth onto an elastomer film, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology which utilize radiation sampling techniques for obtaining information related to reservoirs or other formation attributes. According to an embodiment, a radiation detector utilizes a scintillator package having a scintillating crystal. The scintillating crystal is combined with a reflector positioned to reflect light otherwise leaving a surface of the scintillating crystal. The reflector incorporates nano materials, e.g. nano particles or nano fibers, arranged to provide highly reflective properties. By way of example, the nano materials may be fabricated in a separate layer combined with the scintillating crystal or applied directly onto a surface of the scintillating crystal.

The radiation detector may have a variety of forms, sizes and configurations depending on the parameters of a given data acquisition operation. One type of radiation detector, for example, comprises a scintillating crystal and a photomultiplier tube or other device able to convert a scintillator light signal into an electric current. The scintillating crystal generally comprises a material having properties which convert nuclear radiation into optical radiation, e.g. light, having wavelength(s) readily sensed by the photomultiplier tube.

The performance of the scintillator type radiation detector is related to the quantity of light produced by the scintillating crystal and detected by the light sensing device, e.g. photomultiplier tube. Embodiments of the radiation detector described herein are able to optimize light collection, thus ensuring that a high proportion of light produced by the scintillator assembly reaches the light sensing device. As described in greater detail below, a reflector is disposed along a surface of the scintillating crystal to ensure that light is reflected and re-directed back into the scintillating crystal to increase the probability of light reaching the light sensing device. By way of example, the reflector may be disposed along the entire scintillating crystal surface except for the surface(s) coupled with the light sensing device. In some embodiments, the reflector may be disposed along a portion or portions of the scintillating crystal surface.

According to various embodiments described herein, the reflector is constructed with nano structures having high levels of light reflectivity and which are not detrimentally affected by temperatures and pressures found in, for example, a wellbore environment. Examples of suitable nano structures include nano fibers or nano particles of quartz (SiO2), titanium dioxide (TiO2), and/or aluminum oxide (AIO). Nano structures are structures having a primary dimension equal to or less than 1 micro meter. For example, the primary dimension of a nano particle is the diameter of the particle and the primary dimension of a fiber is the cross-sectional diameter of the fiber. In some embodiments, the nano structures have a primary dimension equal to or less than 0.5 micro meter. In some embodiments, the nano structures have a primary dimension equal to or less than 0.3 micro meter. In some embodiments, the nano structures have a primary dimension equal to or less than 0.1 micro meter.

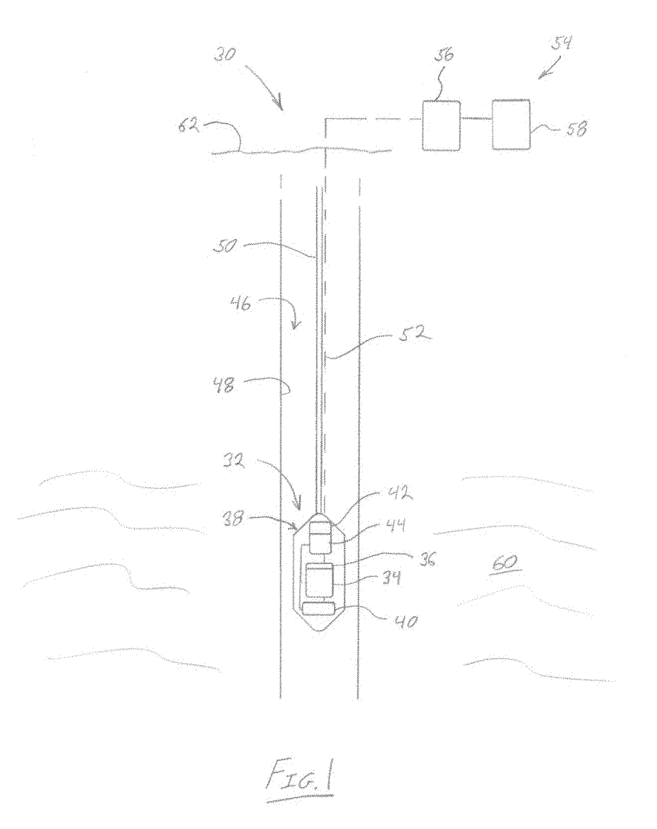

Referring generally to FIG. 1, an embodiment of a well system 30 utilizing a radiation detection system 32 is illustrated. In this embodiment, the radiation detection system 32 comprises a radiation detector 34, e.g. a scintillator package, coupled with a signal processor 36 for processing the light signals received from the scintillating crystal. By way of example, the radiation detector 34 may be disposed in a sonde 38 along with a radiation generator 40, e.g. a neutron generator. Other components of sonde 38 may comprise a radiation generator controller 42 and downhole telemetry circuitry 44 for communication with the surface.

In the example illustrated, the sonde 38 is deployed downhole in a wellbore 46 which may be an open borehole or a borehole lined with, for example, a steel casing 48. The sonde 38 may be conveyed downhole via a conveyance 50 which may be in the form of a cable, coiled tubing, or other suitable conveyance. Additionally, a signal carrying cable 52 may be coupled between sonde 38 and a surface control system 54. By way of example, the cable 52 may be used for carrying power signals and/or data signals. The surface control system 54 may comprise components suitable for a given operation, such as power supply and telemetry circuitry 56 and a signal analyzer 58. The circuitry 56 may be used for controlling the power supply to radiation generator 40 and for communicating with downhole telemetry circuitry 44.

During a detection operation, the radiation generator 40 is powered and emits radiation, e.g. neutrons, which irradiate a desired region of a geologic formation 60 surrounding the sonde 38. In this example, the irradiation causes gamma rays to be returned from the formation 60 and those gamma rays are detected by the one or more radiation detectors 34. Signals from the radiation detector(s) 34 are directed to the signal processor 36 and then communicated to the surface 62 via downhole telemetry circuitry 44, cable 52, and surface telemetry circuitry 56. The signals may then be further analyzed by signal analyzer 58 to determine the desired information regarding geologic formation 60. In some embodiments, the signal analyzer 58 is a processor-based system, such as a computer system able to execute signal analysis software.

Generally, different elements of the geologic formation 60, e.g. oil, gas, water, and other elements, have radiation signatures which are distinct from each other. The distinct radiation signatures may be processed and used to identify these various elements. In some applications, part of the signal processing or the entire signal processing may be conducted downhole in, for example, sonde 38.

Referring generally to FIG. 2, an embodiment of radiation detector 34 is illustrated. In this example, the radiation detector 34 is in the form of a scintillator package having a scintillator 64 which may be referred to as a scintillating crystal. The scintillating crystal 64 converts returning radiation into optical, e.g. light, signals. As illustrated, the scintillating crystal 64 is surrounded by a reflector 66 constructed so that light otherwise leaving the scintillating crystal 64 along the outer lateral or radial surface is reflected and directed back into the scintillating crystal 64. This ensures that a greater amount of light is reflected through an optical window 68 disposed at a longitudinal end of scintillating crystal 64. The scintillating crystal 64 effectively transforms the radiation signals received into light and the reflector 66 increases the amount of this light directed through optical window 68 to the signal processor 36. As described above, the signal processor 36 may be in the form of a photomultiplier tube or other suitable device able to convert the light signals from scintillating crystal 64 into electric current signals which may be transmitted to signal analyzer 58.

Depending on the application, the scintillator-based radiation detector 34 also may comprise other components. For example, the radiation detector 34 may comprise a protective housing 70, e.g. a metal housing, disposed around reflector 66. Additionally, the radiation detector 34 may comprise a reflector pad 72 disposed across a longitudinal end of the scintillating crystal 64 opposite optical window 68. The reflector pad 72 also helps reflect light toward the opposite longitudinal end of crystal 64 and through optical window 68.

In some embodiments, the reflector pad 72 may be held in place by a spacer 74, e.g. a metal spacer, a spring 76, e.g. a compression spring, and an end cap 78. In this example, the spacer 74 may be positioned against reflector pad 72 and the spring 76 may be located between spacer 74 and end cap 78. The end cap 78 may be threadably engaged with protective housing 70 or otherwise suitably secured to the protective housing 70 or other adjacent structure. Similarly, the optical window 68 may be coupled with, e.g. threadably engaged with, protective housing 70 or held by another suitable, adjacent structure.

In the embodiment illustrated in FIG. 2, the scintillating crystal 64 is generally circular in cross-section and the reflector 66 is formed as a separate layer or sleeve 80 which may be placed along the circumference of the scintillating crystal 64 and secured to the scintillating crystal 64 and/or protective housing 70. By way of example, the reflector layer 80 may be formed with a reflective compound of oxides in an organic binder. It should be noted that certain components such as the optical window 68, spacer 74, and/or spring 76 may be eliminated for some applications. For example, the optical window 68 may be eliminated when using scintillating crystals 64 in the form of non-hygroscopic crystals or crystals that do not react with the environment. The spacer 74 and spring 76 may be eliminated if axial pressure is not utilized or they can be replaced with other mechanisms able to apply the desired axial force.

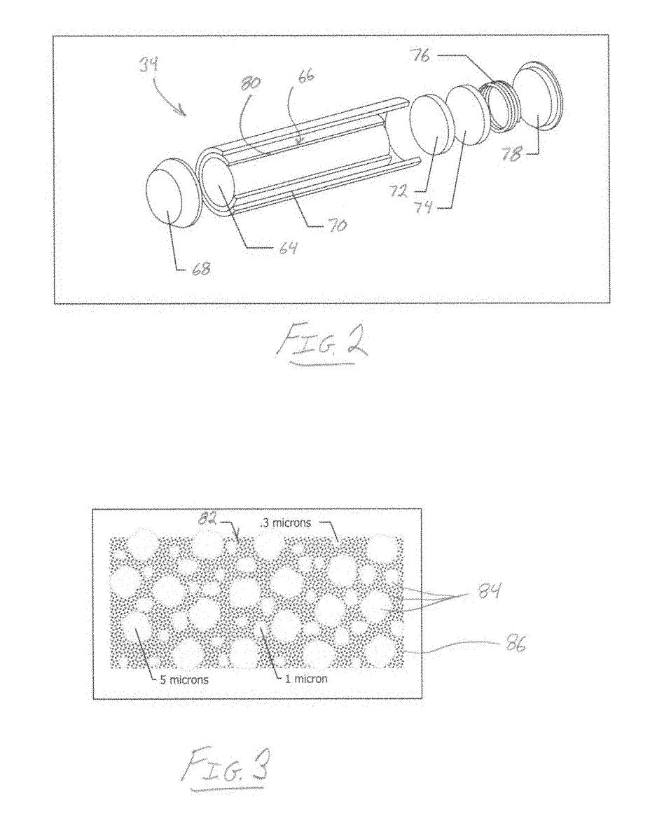

The reflector 66, e.g. reflector layer/sleeve 80, may be formed of a mixture 82 of inorganic structures 84, e.g. reflective oxides, combined with a clear or translucent binding substance 86, e.g. an organic binder, as illustrated in FIG. 3. The inorganic structures 84 may comprise, for example, particles and/or fibers. In some embodiments, the mixture 82 may be cast in place and cured such that it adheres to an inside diameter of protective housing 70 and/or to the outside of insulating crystal 64. The mixture 82 also may be molded into a stand-alone sleeve which is adhered or not adhered in the annular space between the scintillating crystal 64 and the protective housing 70. In this manner, the reflector 66 may be formed as a single substrate able to provide both mechanical protection via the organic binding substance 86 and reflective properties via the inorganic structures 84.

The materials used for structures 84 and/or binding substance 86 may vary depending on the parameters of a given application. For example, the binding substance 86 may comprise an organic binder material, e.g. a silicone material, having a low water absorbing optically clear gel in which water absorption in the material is less than 0.1% as measured by ASTM D570-98 (2005). According to an example, the organic binder material 86 may be a substance labeled “PP2-OE41” which is available from Gelest Inc. Another embodiment of organic binder material 86 is an optical gel from Nusil Silicone Technology, e.g. gel LS 3140. The organic binder 86 also may be a polymer showing non-Newtonian fluid characteristics and exhibiting visco-elastic properties. The molecular weight of such polymer may vary and can range from Poly (styrene) to Poly (di-methylsiloxane). Examples of such polymers are commercially available as LS 6140, LS-6941, LS-6946, or LS-8941 from NuSil Silicone Technology and/or Sylgard™ 184 or Sylgard™ 186 available from the Dow Corning group along with similar compositions available from Shin-Etsu Silicones, Rhodia Group, and Wacker Chemie. The organic binding substance 86 also may comprise a combination of these materials in, for example, ratios from 1:1 to 1:3 by volume.

Similarly, the inorganic material used to form inorganic structures 84, e.g. particle/fibers, may comprise a variety of materials, including combinations of materials, such as combinations of metal oxides, nitrites, and/or sulfates. For example, the inorganic particles 84 may comprise one or more of BaSO₄, TiO₂, BaTiO₃, Al₂O₃, MgO, BN or other suitable materials. In some embodiments, the inorganic particles 84 are TiO₂, Al₂O₃, or a mixture of TiO₂ and Al₂O₃. Various combinations of these materials may be used in ratios varying in a range from, for example, 1:1 to 1:3 by volume. According to a specific example, the mixture 82 comprises inorganic structures 84 formed from aluminum oxide (Al₂O₃) as the inorganic material. The inorganic material forming structures 84 may be selected such that the inorganic structures 84 are capable of reflecting a majority portion of the incident light within the far UV to Visible range of the optical spectrum.

According to a specific example, the mixture 82 comprises inorganic structures 84 formed from aluminum oxide (Al₂O₃) as the inorganic material. The structures 84 may have a variety of shapes and may include nano particles having a size equal to or less than 1 micron. In an embodiment, the inorganic particles 84 have two or more different particle size distributions ranging from 0.3 to 5 microns, as illustrated in FIG. 3. For example, the inorganic particles 84 may have three different particle size distributions around 0.3 microns, 1 microns, and 5 microns, respectively. Other particle size distributions and combinations can be used by people skilled in the art with the benefit of the current disclosure. The material may be randomly distributed and achieved by mixing different particle powders into the binding substance 86. The ratio of the two different particle size powders may vary, for example, from (1:1) to (1:3) by volume for coarse versus fine particle sizes. In some embodiments, the inorganic particles 84 may be applied in a graduated fashion through layer 80, starting from the smaller particle size to the larger particle size, as illustrated in FIG. 4. Depending on the application, the side of layer 80 with smaller particles or the side of layer 80 with larger particles may be oriented to interface with the scintillating crystal 64. Depending on the application, the inorganic structures 84 may comprise nano structures combined with larger structures and the reflector 66 may thus comprise a combination of structures having sizes less than 1 micro meter and greater than 1 micro meter, e.g. up to 5 microns

In some applications, the boundaries of the inorganic structures 84 may at least partially protrude outside the boundaries of the binding material 86. Some embodiments of reflector 66 also may incorporate barium sulfate, having a particle size ranging from 1-4 microns, mixed with fine aluminum oxide powder. The thickness of such reflectors 66 may vary between, for example, 0.40 inches and 0.120 inches or thicker depending on the suitability of the application. The homogeneous mixture 82 can be outcast and casted into custom shape at a suitable temperature, e.g. 150-200° C.

The reflective layer 80 may be prepared according to various techniques including preparing the mixture 82 in an initial liquid or viscous state. In this example, the mixture is cast using a mold and formed into a reflective sleeve 80 sized to fit over the scintillation crystal 64. By way of example, the mold may be made of metal, e.g. aluminum or steel, plastics, with PTFE based materials, PTFE coated metals, or combinations materials. Once the mixture 82 is cast into a desired shape, it may be out gassed and cured into a flexible or pliable solid form.

Depending on the molding technique employed, a primer (such as Nusil® CF2-135 or Dow Corning® Sylgard Primer) may be applied such that the sleeve 80 will adhere to the inner diameter of the housing 70. A removable mold may be placed in the location of the scintillating crystal 64. In another example, a primer may be applied to the surface of the scintillating crystal 64, such that the material of mixture 82 adheres to the outer diameter of the crystal surface. In this example, a removable mold may be placed in the location of housing 70. Additionally, the mixture 82 may be cast (with or without primers) directly into the annulus between the scintillating crystal 64 and the protective housing 70 without utilizing a separate mold.

Furthermore, the mold may have a variety of shapes for producing reflective sleeves 80 with a corresponding variety of shapes. For example, the reflector 66, e.g. reflective sleeve 80, may be molded with a smooth or non-smooth outer or inner surface. Referring generally to FIGS. 5-8, examples of molded reflective sleeves 80 are illustrated. In these embodiments, the reflective sleeves 80 are formed with molds constructed to provide voids, e.g. gaps, along the interior and/or exterior surface of the reflector 66.

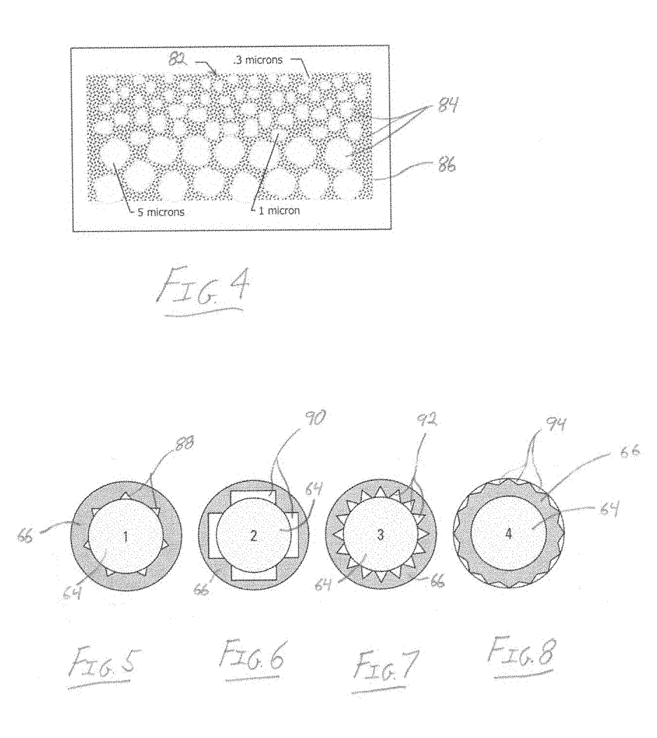

For example, triangular voids 88 may be located along an interior surface of the reflective sleeve 80 and adjacent scintillating crystal 64, as illustrated in FIG. 5. In another example, rectangular voids 90 may be located along an interior surface of the reflective sleeve 80 and adjacent scintillating crystal 64, as illustrated in FIG. 6. In another example, a larger number of differently shaped triangular voids 92 may be located along an interior surface of the reflective sleeve 80 and adjacent scintillating crystal 64, as illustrated in FIG. 7. However, triangular voids or otherwise shaped voids 94 also may be positioned along an exterior surface of reflective sleeve 80, as illustrated in FIG. 8. The voids 88, 90, 92, 94 may have other shapes and configurations and may extend longitudinally along the sleeve 80 or may be arranged in other orientations.

The voids 88, 90, 92, 94, e.g. gaps, have various functionalities, such as providing free volume for expansion of the binding material 86, e.g. silicone, at high temperatures, thus reducing the potential for damaging the scintillating crystal 64. It should be noted, however, the overall thermal expansion of reflector layer 80 is reduced due to the inclusion of the inorganic particles 84. In some embodiments, the voids/gaps 88, 90, 92, 94 may be filled with other materials, e.g. additional oxide powder to improve reflectance; PTFE-based reflective material; or shock absorbing elastomers. The voids/gaps may have a variety of sizes and configurations. When the binding material 86 is formed of certain materials such as silicone, the overall mixture 82 becomes resilient to compression set following numerous thermal cycles. Furthermore, the use of thermally stable inorganic oxides to form structures 84 provides a much higher level of reflectivity compared to, for example, reflectors formed of PTFE.

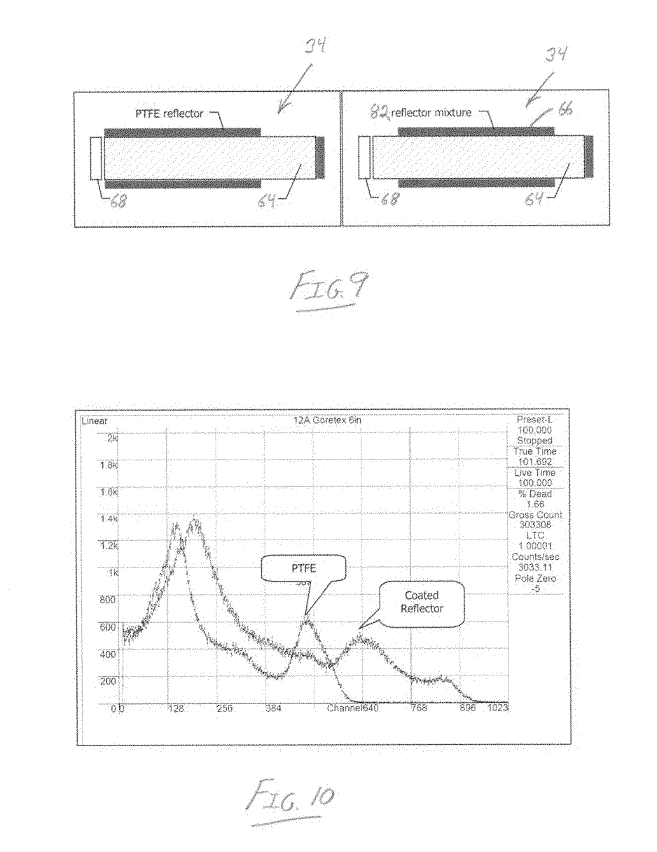

Referring generally to FIG. 9, a schematic illustration is provided of two radiation detectors in which one includes a reflector formed of PTFE (left side) and one comprises the reflector 66 described herein and formed of mixture 82 (right side). In this particular example, the scintillating crystal 64 is formed of NaI(Tl) and the reflector 66 (right side) is formed with mixture 82 having inorganic particles 84 comprising aluminum oxide particles and binding substance 86 comprising silicone gel, e.g. an Al₂O₃+Nusil compound. A comparison of the response of the left and right side radiation detectors to radiation from a Cs-137 radiation generator 40 is illustrated graphically in FIG. 10.

It should be noted with respect to FIG. 10 that the difference in location of the reflectors with respect to their scintillating crystals 64 caused a double peak in the data obtained from the right side radiation detector 34, i.e. the radiation detector utilizing the reflector 66 formed with mixture 82. However, the data graphically represented in FIG. 10 clearly shows that the mixture 82 of reflector 66 (right side in FIG. 9) provides a brighter light output from the scintillating crystal 64. In FIG. 11, the graphical results of another experiment are provided which also demonstrate the brighter light output from scintillating crystal 64 when combined with reflector 66 having an appropriate mixture 82. In this latter example, the scintillating crystal 64 was again a NaI(Tl) crystal but the crystal 64 was surrounded along its entire length with reflector 66 comprising Al₂O₃+Nusil compound. Radiation was again provided by a Cs-137 source.

Depending on the parameters of a given data collection operation, one or more radiation detectors 34 may be employed and may have various configurations. Additionally, the components of the radiation detector 34 may be made from a variety of materials and in suitable shapes. For example, the scintillating crystal 64 and/or reflector 66 may have a variety of cylindrical shapes and sizes.

The organic binder substance 86 may comprise a variety of compounds, including commercially available compounds such as: Sylgard™ 184 or Sylgard™ 186 available from the Dow Corning group; LS-3140, LS-6140, LS-6941, LS-6946 or LS-8941 available from NuSil® Technology group; and similar compositions available from Shin-Etsu Silicones, Rhodia Group and Wacker Chemie. The inorganic structures 84 may comprise nano particles having size of 1 micron or less, but the particles or other structures 84 also may have a range of sizes, e.g. sizes ranging from 0.3 to 5 microns. The inorganic structures 84 also may be reflective in the far UV to visible range. Specific compounds from which the structures 84 are formed may include BaSO₄, TiO₂, BaTiO₃, Al₂O₃, MgO, BN, other suitable compounds and combinations of such materials.

Similarly, the scintillating crystal 64 may be constructed from various suitable materials, such as NaI(Tl), CsI(Tl), CsI(Na), LaBr3:Ce, LaC13:Ce, CeBr3, SrI2: Eu, BGO, GSO:Ce, GPS(Ce) (LuAlO3)LuAP:Ce, (Lu3Al5O12)LuAG:Pr, LuYAP:Ce, and (YAlO3)YAP:Ce. In some applications, the scintillating crystal 64 or the entire scintillating crystal radiation detector package 34 may be hermetically sealed. However, some applications may not utilize hermetically sealed crystals or packages. Depending on the embodiment, an optical coupling may be provided between the optical window 68 and the scintillating crystal 64. Some embodiments may eliminate the optical window 68, while other embodiments may share the optical window 68 between the crystal 64 and the signal processor 36. Similarly, some embodiments may utilize the spring 76 to maintain an axial pressure against the scintillating crystal 64 and/or optical window 68.

Various molding techniques also may be employed to form the reflective layer or sleeve 80. By way of example, mixture 82 may be produced in liquid form and then cast to form the solid sleeve 80. The mold used to form reflective sleeve 80 may be constructed from metals, PTFE, PTFE coated metals, plastics, glass, or other suitable materials. Adhesives also may be used in combination with the cast reflector 66/sleeve 80 to facilitate secure placement of the reflector 66 about scintillating crystal 64. The desired adhesion may be provided by a commercially available primer, e.g. Sylgard primer or Nusil primer. Additionally, the reflector sleeve 80 may be adhered to the inside diameter surface of protective housing 70 and/or to the outside diameter surface of the scintillating crystal 64. The reflector sleeve 80 also may be positioned as an independent layer/sleeve without the use of adhesives. In some embodiments, the reflector sleeve 80 may be in the form of a paint that can be adhered to the inside diameter surface of protective housing 70 and/or to the outside diameter surface of the scintillating crystal 64.

Depending on the molding technique and materials selected, various curing procedures also may be employed. Some curing procedures may be performed at room temperature, while other procedures are performed at elevated temperatures. The cured reflector 66 also may be formed with voids/gaps filled with air or other materials.

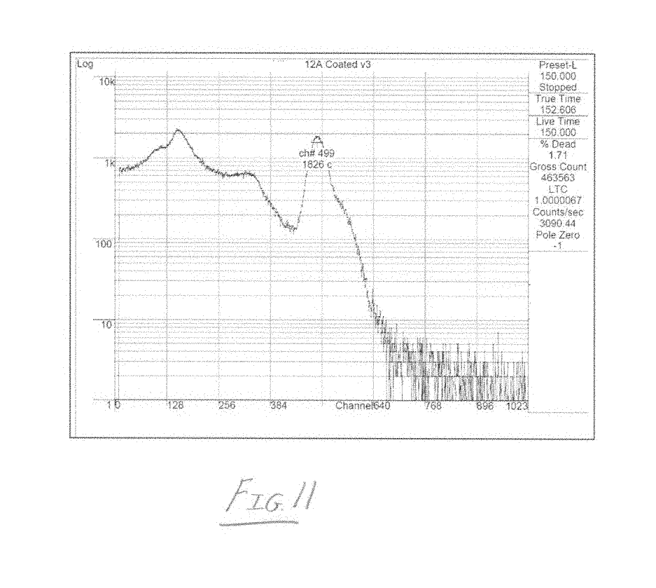

In another embodiment, the reflector 66 is formed as a nano structure material 96 and applied directly to an exterior surface 98 of scintillating crystal 64, as illustrated in FIG. 12. The nano structure material 96 comprises nano structures positioned to form reflector 66 such that light is reflected and prevented from escaping through the outer surface 98 of scintillating crystal 64. The nano structure material may include material with a high transparency to the wavelengths of interest or it may be opaque but with high reflective properties. In the case of high transparency material, the light refracts off the surface of the nano structure material and/or the light enters the material and exits with a very low loss after being reflected by nanostructures 100. In the case of the opaque but reflective material, the light simply reflects off the surface.

Referring again to the embodiment illustrated in FIG. 12, the reflector 66 is formed by nano structure material 96 which comprises the nano structures 100, e.g. nano particles or nano fibers, deposited onto the outer surface 98 of scintillating crystal 64. By way of example, the nano structures 100 may be electron beam deposited onto the scintillator 64. However, the nano structures 100 may be applied to the surface 98 by other techniques, such as sintering nanoparticles or nano fibers onto the scintillating crystal 64. The nano structures 100 are structures with a primary dimension equal to or less than 1 micro meter. For example, the primary dimension of a nano particle is the diameter of the particle and the primary dimension of a fiber is the cross-sectional diameter of the fiber. In some embodiments, the nano structure material 96 also may comprise larger structures, e.g. larger particles or fibers, mixed with the smaller nano structures. This is similar to the inorganic structures 84, described above, which may comprise nano structures mixed with larger structures.

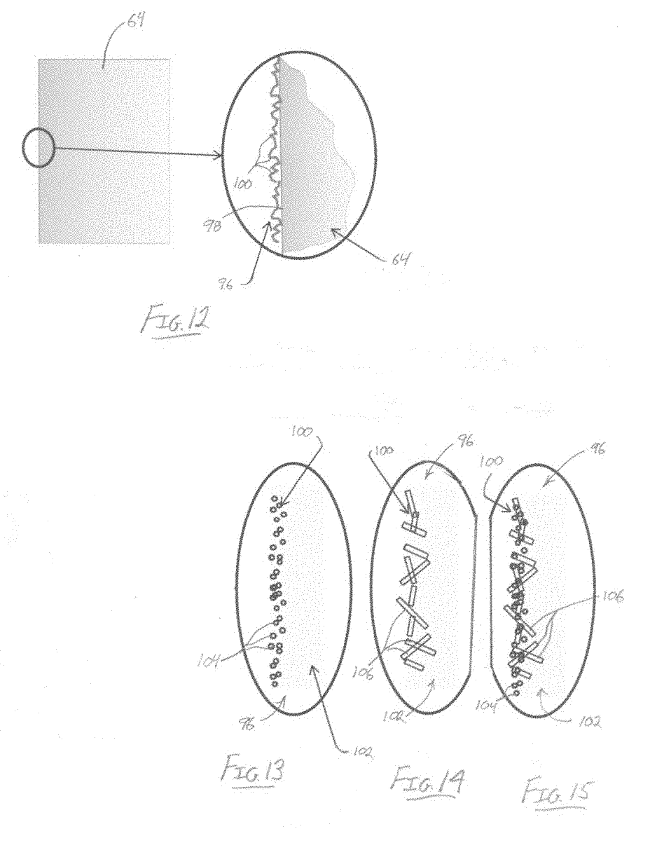

In some applications, the nano structures 100 may be deposited onto surface 98 of the scintillating crystal 64 and then coated with a layer, e.g. a silica membrane, to stabilize the layer of nano structures. By way of example, the silica membrane may be applied to surface 98 via a vapor deposition technique. Additionally, the nano structures 100 may be deposited onto a substrate 102 which is stable at high temperature, e.g. a substrate formed from silicon elastomer, as illustrated in FIGS. 13-15. By way of example, nano structures 100 may comprise nano particles 104 deposited into the substrate 102, as illustrated in FIG. 13. The nano structures 100 also may comprise nano fibers, e.g. tubes, 106 deposited into the substrate 102, as illustrated in FIG. 14. The nano structures 100 may further comprise a mixture of structures, such as a mixture of nano particles 104 and nano fibers/tubes 106, as illustrated in FIG. 15.

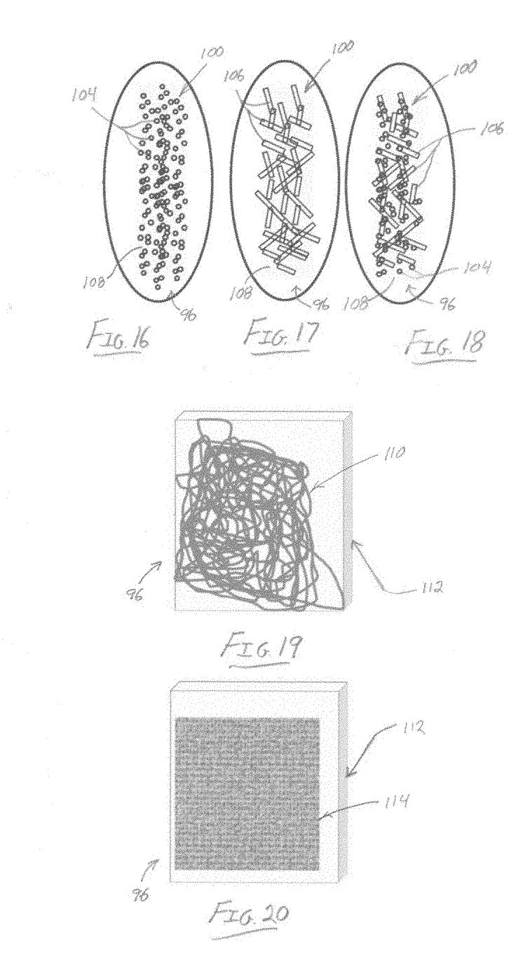

Referring generally to FIGS. 16-18, embodiments are illustrated to represent the suspension of nano structures 100 into a transparent substrate 108, such as a high temperature transparent, silicon elastomer matrix. Again, the nano structures 100 may comprise nano particles 104 deposited into the substrate 108, as illustrated in FIG. 16. The nano structures 100 also may comprise nano fibers/tubes 106 deposited into the substrate 108, as illustrated in FIG. 17. The nano structures 100 may further comprise a mixture of structures, such as a mixture of nano particles 104 and nano fibers/tubes 106, as illustrated in FIG. 18.

The reflector 66 also may be formed with other nano-based structures. As illustrated in FIG. 19, for example, the reflector 66 may be formed with a random nano fiber network 110. The random network 110 may be adhered or otherwise applied to a film 112, e.g. a silicon elastomer film, deposited onto or otherwise applied to the outer surface 98 of scintillating crystal 64. Similarly, an ordered nano fiber network 114, e.g. a nano fiber cloth, may be combined with film 112 (as illustrated in FIG. 20) and applied to the scintillating crystal 64 to serve as the reflector 66. By way of example, these types of nano-based structures may be produced through electro-spinning to produce organized “weaved” cloth or random “felt” formed with nano fibers.

Depending on the parameters of a given application and/or environment, the structure of overall well system 30 as well as the structure of each radiation detector 34 may be adjusted. With respect to the radiation detector 34, various types of scintillating crystals 64 may be combined with various mixtures of materials to form a reflector 66 with a high level of reflectivity. Additionally, the reflector 66 may be formed as a separate layer, e.g. sleeve, or the reflector 66 may be directly deposited or otherwise applied to the outer surface of the scintillating crystal 64.

Certain embodiments of reflector 66 described herein provide a high level of reflectivity while also providing protection against mechanical forces. The materials used to form the reflector 66, e.g. nano structures, substantially increase the amount of useful light generated by the scintillating crystal and passed to the corresponding signal processor. The materials and configurations of the scintillating crystal and the reflector may be selected according to the parameters of a given environment and data collection operation.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A system for detecting radiation from a subterranean formation penetrated by a wellbore, comprising:
a radiation detector having a scintillating crystal surrounded by a reflector, the reflector comprising nano structures arranged to provide an enhanced reflectivity with respect to light, the nano structures having primary dimensions equal to or less than 1 micro meter.

2. The system as recited in claim 1, wherein the nano structures are deposited on an exterior surface of the scintillating crystal.

3. The system as recited in claim 1, wherein the nano structures are held in a substrate.

4. The system as recited in claim 1, wherein the nano structures are held in a transparent substrate.

5. The system as recited in claim 1, wherein the nano structures are contained in a sleeve formed with a moldable organic binder material.

6. The system as recited in claim 5, wherein the sleeve further comprises structures larger than one micro meter distributed in the organic binder material.

7. The system as recited in claim 5, wherein the sleeve comprises structures, including the nano structures, distributed in the organic binder material and having a range of sizes smaller and larger than one micro meter.

8. The system as recited in claim 1, wherein the nano structures are inorganic particles.

9. The system as recited in claim 1, wherein the nano structures are inorganic fibers.

10. A system, comprising
a sonde deployable in a borehole, the sonde comprising a radiation detector, a signal processor in communication with the radiation detector, a radiation generator, and telemetry circuitry, the radiation detector comprising:
a scintillating crystal;
an optical window through which light signals are directed from the scintillating crystal to the signal processor; and
a reflector to increase the quantity of light signals passing through the optical window to the signal processor, the reflector having inorganic nano structures arranged to provide an enhanced reflectivity with respect to light, the inorganic nano structures having primary dimensions equal to or less than 1 micro meter.

11. The system as recited in claim 10, wherein the reflector comprises the inorganic nano structures mixed into an organic material.

12. The system as recited in claim 11, wherein the organic material and the inorganic nano structures are combined in a mixture moldable into a desired shape.

13. The system as recited in claim 10, wherein the nano structures are deposited directly onto the scintillating crystal.

14. The system as recited in claim 10, wherein the sonde is deployed into a wellbore and placed in communication with a surface control system.

15. The system as recited in claim 10, wherein additional structures are combined with the nano structures to provide structures having a range of sizes from less than 1 micro meter to more than 1 micro meter.

16. The system as recited in claim 10, wherein the reflector is molded as a sleeve and positioned between the scintillating crystal and a protective housing.

17. A method, comprising:
providing a scintillating crystal to detect radiation from a subterranean formation penetrated by a wellbore and to convert to radiation to light signals;
surrounding at least a portion of the scintillating crystal with a reflector comprising nano structures arranged to increase the reflectivity of the reflector; and
positioning the reflector such that a greater amount of light is retained in the scintillating crystal, due to the reflectivity of the nano structures, until the light is directed out of the scintillating crystal to a signal processor.

18. The method as recited in claim 17, further comprising disturbing the nano structures in a substrate.

19. The method as recited in claim 17, further comprising disputing the nano structures in a moldable sleeve formed with an organic binder material.

20. The method as recited in claim 17, further comprising directly depositing the nano structures onto an exterior surface of the scintillating crystal.
